(19) United States
(12) Patent Application Publication
(10) Pub. No.: US 2007/0125272 A1
(43) Pub. Date: Jun. 7, 2007

(54) Geopolymer concrete and method of preparation and casting

(75) Inventor: Gregory Balfour Johnson, New South Wales (AU)

Correspondence Address: NORRIS, MCLAUGHLIN & MARCUS, 875 THIRD AVE, 18TH FLOOR, NEW YORK, NY, 10022, US

(73) Assignee: ROCLA PTY LTD, Chatswood, New South Wales (AU)

(21) Appl. No.: 10/595,915

(22) PCT Filed: Nov. 19, 2004
(86) PCT No.: PCT/AU04/01608

§ 371 Date: Jun. 28, 2006

Related U.S. Application Data
(60) Provisional application No. 60/523,117, filed on Nov. 19, 2003.

(51) Int. Cl. C04B 28/00; C04B 18/06; C04B 14/00

(52) U.S. Cl. 106/638; 106/705; 106/817

(57) ABSTRACT

A method of forming a geopolymer moulded product comprising: forming a geopolymer concrete composition comprising an alkali or alkaline earth metal silicate component, an alkali or alkaline earth metal hydroxide, aggregate and water wherein the water content is insufficient to provide a slumped concrete and the ratio of SiO₂ to M₂O is at least 0.8; and casting the concrete into a mold and subjecting the moulded concrete to consolidation in the mold.

### FIELD

The present invention relates to geopolymer based concrete and to methods of casting concrete based on geopolymers to form products such as pipes, poles, railway sleepers and the like.

### BACKGROUND

Geopolymers consist of silicon and aluminium atoms bonded via oxygen into a polymer network. Geopolymers are prepared by dissolution and poly-condensations reactions between an aluminosilicate binder and an alkaline silicate solution such as a mixture of an alkali metal silicate and metal hydroxide.

In contrast to concrete formed from Ordinary Portland Cement (OPC), a geopolymer concrete will exhibit greater heat, fire and acid resistance. This type of concrete is particularly useful for making precast concrete products that will be used in corrosive environments.

Unlike concrete made from ordinary Portland cement, which has a delay period before the concrete starts to harden, the process of forming geopolymers involves a dissolution/condensation/poly-condensation/polymerization reaction which begins as soon as the alkali silicate comes into contact with the aluminosilicate binder. As a result the geopolymer concrete gains strength rapidly. This is recognized by Davidovits et al in U.S. Pat. No. 4,509,985 who report a high early strength geopolymer having the ratios M₂O/SiO₂ of 0.20 to 0.48, SiO₂/Al₂O₃ of 3.3 to 4.5, H₂O/M₂O of 10.0 to 25.) and M₂O/Al₂O₃ of 0.8 to 1.6 the resulting product is said to provide very rapid strength gain allowing more rapid reuse of molds in the casting operation.

Silverstrim et al, in U.S. Pat. No. 5,601,643, describe a high strength cementitious binder containing fly ash and alkali silicate solution. The product is said to provide rapid strength by use of a SiO₂:Na₂O ratio of about 0.20:1 to about 0.75:1 (preferably about 0.5:1 to about 0.6:1).

Hardjito et al of Curtin University of Technology studied the effect of different mix design variables in their paper “The Engineering Properties of Geopolymer Concrete” (Concrete in Australia, December 2002-February 2003, pp 24-29). The geopolymer concrete is prepared by the method of mixing the aggregates and fly ash and adding the alkaline solution to this dry mix. Hardjito et al report that the compressive strength of geopolymer concrete, unlike OPC concrete does not increase with aging. In their subsequent work Hardjito et al study the use of naphthalene based superplasticizer to delay the onset of curing and allow the concrete to be handled for up to 120 minutes without any sign of setting.

The present inventor found that geopolymer concrete, of previously reported composition and prepared by previously reported techniques, cannot be used with the usual manufacturing processes for pipes, poles and the like because the working time is too short. These manufacturing techniques require the use of concrete with a ‘No Slump’ consistency and the inventor found that the low fluid content of this concrete was responsible for the short working time. A further shortening of the working time was caused by the vibration and compaction techniques used in the manufacturing process and these two factors made it impossible to form products of acceptable appearance and with properties that allow them to pass the standard requirements. This had not been expected as the work life of Ordinary Portland Cement products is not accelerated in this way.

Geopolymer concrete needs to be cured at elevated temperatures to accelerate the hardening reactions and we found that products of acceptable quality could only be produced if the plastic consistency of the fresh concrete was maintained during the forming and transport of the products to the curing chambers. Transport of the products after they had lost this plastic consistency can result in cracking and a reduction in the final strength of the product. If the manufacture of these products is to be performed on a continuous basis then it is also necessary to maintain the plastic consistency for the time required to make at least two successive batches of concrete.

In many of the casting techniques previously used for Ordinary Portland Cement based concrete the concrete is cast in a relatively dry form. Such concrete is often referred to as “no-slump” concrete as the concrete does not exhibit any measurable slump when placed on a hard flat surface. No-slump concrete based on ordinary Portland cement is used in centrifugal casting of pipes and other dry compaction casting methods. As a consequence of the rapid setting of geopolymer concrete when it is subject to such consolidation methods we found that casting of products presented considerable practical problems. It made it extremely difficult to transfer the laboratory scale observations reported in the literature to commercial scale manufacture of products as the literature does not recognize or allow for the change in the properties of geopolymer concrete which are brought about by subjecting the geopolymer to the conventional consolidation techniques used in manufacture of pipe and the like products.

### SUMMARY

We have now found that geopolymer concrete may be used in preparing pipe and other consolidated moulded products by using a geopolymer concrete which has a “no-slump” consistency and a metal silicate and metal hydroxide component which together provide a ratio of SiO₂/M₂O of at least 0.8 where M is an alkali metal or alkaline earth metal (½ M) and preferably is an alkali metal such as sodium or potassium.

Accordingly we provide a method of forming a geopolymer moulded product comprising: forming a geopolymer concrete composition comprising an alkali or alkaline earth metal silicate component, an alkali or alkaline earth metal hydroxide, aggregate and water wherein the water content is insufficient to provide a slumped concrete and the ratio of SiO₂ to M₂O is at least 0.8; and casting the concrete into a mold and subjecting the moulded concrete to consolidation in the mold. Preferably the ratio of SiO₂ to M₂O is at least 0.9 and most preferably it is at least 0.95. Typically the ratio will be less than 1.2.

We also found that concrete with acceptable working time could be obtained by restricting the water added at the start of the mixing sequence. It is usual practice to begin a mixing cycle by adding the aggregate components to the mixer and those aggregates will typically be added in an ‘as received’ moisture condition. When this usual practice is followed with a geopolymer concrete mix, the water contributed by the aggregate was found to shorten the working time. To overcome this problem we prefer to precondition the aggregate in a way that will restrict the water addition at the start of the mixing cycle.

We also found that more uniform workability could be obtained, that would allow the concrete to be compacted more easily and produce a better surface finish by using a certain order of addition for the components. The method of preparation comprised forming a mixture of at least part of the aggregate with a metal hydroxide and combining this mixture with an aluminosilicate binder followed by a metal silicate and a final water addition.

The composition and process of the invention is particularly suited to use in the preparation of pipe.

### DETAILED DESCRIPTION

We found that by manipulating these aspects of the invention that adequate working time could be achieved, which would allow geopolymer concrete to be used for making pipes, poles and the like by the normal manufacturing techniques. The manipulation of these aspects still allows the concrete to achieve rapid strength growth during the curing process and produce products of typical dimensions that comply with the appropriate standard requirements.

Concrete used for the production of pipes, poles and the like has a very stiff consistency and it is generally referred to as being ‘No Slump’ concrete. No slump concrete may be defined as concrete which exhibits no measurable slump when subject to the slump test set out in Australian Standard AS1012.3.1 (1998) “Determination of Properties Related to the Consistency of Concrete—Slump Test”. The fresh concrete will appear extremely harsh due to the high proportion of stone in the mix but with vibration and/or compaction the concrete will take the shape of the mold and provided it has sufficient cohesiveness or ‘green’ strength it will hold that shape without caving in. A more accurate measure of the consistency of this type of concrete can be obtained by performing the test: ASTM C1170—Determining Consistency and Density of Roller-Compacted Concrete Using a Vibrating Table. In this test the concrete is subjected to vibration and compaction with a fixed mass until most air void have been eliminated and free paste can form a continuous film around a clear plastic disk. In many ways the test mimics the compaction that concrete undergoes in the roller suspension pipe making process so it does give a good indication of how the concrete will perform under actual manufacturing conditions.

In a particularly preferred embodiment the concrete has a Vebe Time that is high enough to avoid the concrete slumping away from the mold after completion of the compaction process but not so high that the concrete is too stiff to be compacted so that it adequately fills the mold. In the normal manufacturing processes for pipes, poles and the like the products are cast within 30 minutes of mixing so it is important that the concrete maintain an acceptable level of consistency over this period and if production is to be performed on a continuous basis, without cleaning of equipment between mixing batches of concrete, then it is preferable to maintain this consistency for 45 minutes or longer. Vebe Time can be used as a measure of this consistency and to meet all of the requirements a suitable range in values is:
At 15 minutes after mixing Vebe Time=15 to 40 seconds (preferably 15 to 35 seconds)
At 30 minutes after mixing Vebe Time=15 to 50 seconds (preferably 15 to 40 seconds)
At 45 minutes after mixing Vebe Time=15 to 60 seconds
   The exact value for the Vebe Time, within the range specified, will depend on several factors including aggregate type and the pipe diameter.

The Vebe Time is determined using Method A from ASTM C1170 and after completion of the test the concrete is removed from the mold and broken by hand, into individual pieces of stone with a coating of sand and paste. This mashed concrete is returned to the Vebe mold so that the test can be repeated on the same sample at 15 minute intervals.

The SiO₂/M₂O ratio in the range 0.20:1 to 0.75:1 was found to be unsuitable because the working time was unacceptably short (often less than 15 minutes). We also found this relatively low ratio leads to the development of faults and inconsistencies, which we believe, may be due to deformation caused by consolidation of the concrete when the concrete had lost its plastic consistency. This phenomenon has, to our knowledge not been previously reported for geopolymer compositions and makes geopolymer concrete much more difficult to mold under the conditions of compaction normally used in molding OPC concrete products. In contrast, by using geopolymer concrete of a No Slump consistency, which has a combination of metal silicate and metal hydroxide that gave a SiO₂/M₂O ratio of at least 0.8, preferably at least 0.9 and most preferably at least 0.95, it was possible to obtain an extension of the working time and still produce products with sufficient strength to comply with standard requirements. The ratio is preferably not more than 1.20.

The aggregate component for the composition will usually be composed of graded sand plus a coarse stone. For pipe making the stone is typically present in an amount of from 40% to 60% by weight of the total weight of dry components in the composition and more preferably from 50 to 57%. The sand is typically present in an amount of from 20 to 45% by weight of the total weight of the dry components and more preferably 25 to 35%. The aggregate components are normally the first addition to the mix and they are normally used in an ‘as received’ moisture condition. Under normal conditions the stone will have a moisture content in the range 0.5 to 2.5% and the sand moisture will be in the range 2 to 7%.

We found that the use of aggregates with moisture contents in this normal range produced concrete reduced working time to cast the products. By making pipes, using the roller suspension process, that ranged in size from 750 to 1800 mm, we found that by restricting the moisture content of the aggregate component that it was possible to extend working times to at least 30 minutes or more which is more convenient for casting the products. To obtain acceptable working time the water added at the start of the mixing process through the use of damp aggregates is preferably restricted to less than 0.8% of the total mass of components and preferably less than 0.5%.

We found it convenient to achieve this requirement by using well drained stone with moisture content less than 1.5% and dried sand with a moisture content less than 0.2%. If the combined moisture in the aggregate components exceeds the specified limit for water added at the start of mixing than an alternative mixing sequence is to start by adding only the proportion of aggregate that keeps the water content below the specified limit and then add the remaining aggregate at the end of the mixing cycle.

If the aggregate component contains more water than the preferred level then a further alternative mixing procedure is to add the metal hydroxide as a solid which will dissolve by absorbing water from the aggregate. The moisture content of the aggregate component would then need to be below the specified limit after decreasing it by the amount required to make the equivalent of a 50% metal hydroxide solution. This is not the preferred method because the heat generated when the metal hydroxide dissolves can increase the temperature of the mix and possibly reduce the working time.

In general we found it convenient to form a preliminary mixture of metal hydroxide solution with the entire aggregate component. The binder component, which comprises an aluminosilicate material, is preferably added after forming the mixture of metal hydroxide and aggregate. Metal silicate is preferably added after the binder and addition of the metal silicate activates the condensation reaction and commences the working time of the concrete.

The process of the invention is particularly suited to manufacture of concrete pipe. The manufacture of concrete pipe typically involves a process selected from centrifugal processes, roller suspension processes and vertical casting processes. These processes generally involve high compactive forces, which we have found to severely reduce the working time of the geopolymer composition

The process of the present invention allows the working time to be extended generally to at least 30 minutes and more preferably at least 45 minutes so that the processes involved in forming and handling prior to curing can be completed

In the centrifugal (or vibrio spin) process a mold is supported on rings and rotated at great speed generally providing a peripheral velocity of 4 to 5 metres per second. The mold is filled and pulse vibrated through supporting rings generally at frequencies from 8 to 130 hertz. The filled mold is screeded during rotation and rolled by a sleeved internal shaft. The rate of spinning is generally increased so as to compact the concrete under a centrifugal force as high as 50 times gravity or more.

In the roller-suspension process, a mold (generally a steel mold containing a steel reinforcing cage) is suspended on a horizontal spindle, called a roller, and rotated while no-slump concrete is fed into the mold mechanically. The concrete is compacted against the mold by centrifugal force and vibration and finally by compression between the roller and the concrete mold. This compaction process which uses a drier concrete than most other processes produces a high strength and is the preferred method for formation of pipe in accordance with the method of the invention.

In the vertical casting process the pipe mold is placed with its axis vertical and the mold filled from above. The concrete is generally compacted by severe vibration and/or localized high roller pressure.

The preferred metal silicate is sodium silicate solution that contains 44% solids with SiO₂/Na₂O ratio of 2.0 and the preferred metal hydroxide is a sodium hydroxide solution that contains 50% solids. When these materials are used the mass ratio of sodium hydroxide solution to sodium silicate solution will be in the range 1:2 to 1:4 and preferable around 1:3. The mass ratio of total water (water in the aggregates+added water) to the silicate/hydroxide solution will vary depending on the aggregate and binder properties but it will generally be in the range 1:1.5 to 1:2.5 and preferably around 1:2. The total mass of fluid present in the mix will vary depending on the aggregate and binder properties but it will generally be in the range 4 to 6% of the total mass of components and preferably around 5%. If the quantity of fluid has to be varied to obtain acceptable rheological properties then the total volume of fluid should be changed so that the ratio of metal hydroxide to metal silicate to water in maintained.

Water has a complex function in geopolymer concrete. We have found that the influence of water on rate of reaction will depend on when it is added during the mixing sequence. If it is added at the start, possibly because the aggregates have high moisture content then it will reduce the initial workability of the mixture.

In an embodiment the method of the invention it is particularly preferred that from half to two thirds of the total water content of the concrete having a water content insufficient to provide a slumped concrete is added to the composition following mixing of the metal hydroxide component and at least part of the aggregate and optionally other components.

The method of the invention involves the formulation of the geopolymers using aggregate, aluminosilicate binder, metal silicate and metal hydroxide. Metal hydroxide is mixed with at least part of the aggregate component as a preliminary step in formation of the geopolymer concrete. The metal hydroxide may be in the form of a solid or an aqueous mixture. Preferably, where the metal hydroxide is an aqueous mixture, the concentration will be at least 30% by weight, more preferably at least 40% by weight and still more preferably at least 45% by weight.

Formation of the geopolymer concrete utilizes a reactive aluminosilicate binder. Examples of reactive aluminosilicate binders from which geopolymers may be formed include fly ash, ground blast furnace slag, metakaolin, aluminium-containing silica fume, synthetic aluminosilicate glass powder, scoria and pumice. These materials contain a significant proportion of amorphous aluminosilicate phase, which is highly reactive in strong alkali solutions. The preferred aluminosilicate for use in the method of the invention are fly ash (particularly Class F fly ash), scoria and blast furnace slag. Mixtures of two or more aluminosilicate may be used if desired.

More preferably the aluminosilicate component comprises fly ash and optionally one or more secondary binder components which may be of ground granulated blast furnace slag, Portland cement, kaolin, metakaolin or silica fume. Typically the fly ash component is at least 70% by weight of the aluminosilicate binder. The fly ash is preferably 10 to 20% by weight of the total dry components and more preferably 10 to 15%.

In the preferred aspect of the invention in which the aluminosilicate binder is primarily composed of fly ash and it has been found that minor additions of a secondary binder component such as ground granulated blast furnace slag or Portland Cement can produce substantial gains in strength and also help to control the rate of reaction.

It is thought that the Portland cement and slag improve strength because they are more reactive than fly ash and dissolve more readily in the alkaline solutions. The greater reactivity of these components produces a higher concentration of ions, which in turn, react to produce a denser network of polymeric chains and greater strength. The greater reactivity of the secondary binder components also helps to even out variations in the reactivity of the fly ash. Because fly ash is produced from power stations that generally operate under variable conditions it tends to also produce variability in the reactivity of the fly ash. This variability can be moderated by including more reactive secondary binder components which help maintain a stable concentration of ions.

Where the binder component contains ground granulated blast furnace slag the concentration will generally be less than 20% by weight and preferably in the range 6 to 10% by weight of the binder components. If Portland cement is used then the concentration will generally be less than 8% by weight, preferably less than 6% and most preferably in the range 1 to 3% by weight of the aluminosilicate binder components.

The metal hydroxide used in the process of the invention is generally an alkali metal hydroxide or alkaline earth metal hydroxide. Alkali metal hydroxides are generally preferred and sodium and potassium hydroxide are the most preferred.

The metal silicate is generally an alkali metal silicate and/or alkaline earth metal silicate. Alkali metal silicates, particularly sodium silicate, are preferred. Sodium silicate with a ratio of SiO₂/Na₂O equal to or less than 3.2 are preferred and equal to 2.0 is most preferred.

Typical examples of compositions of the invention include the following components in the amounts by weight of the total dry components as follows:

40 to 60% course aggregate;

20 to 45% sand;

10 to 20% fly ash and other binder components;

0.5 to 2% sodium silicate; and

0.2 to 0.6% sodium hydroxide

Particularly preferred compositions of the invention comprise the following components in the amounts by weight of the weight of the dry components as follows:

50 to 57% course aggregate;

25 to 35% sand;

10 to 15% fly ash and other binder components;

0.5 to 2% sodium silicate; and

0.2 to 0.6% sodium hydroxide.

The method of the invention will generally be used in combination with a casting process and in particular a casting process for preparation of pipes. The casting process will typically involve a compaction step in which the geopolymer concrete is compacted within a mold using techniques such as centrifugal compaction and/or compaction between a roller and the mold. In the casting process the cast geopolymer will generally be subject to a steam curing step. Curing will typically be conducted at a temperature in the range of from 40 to 90° and more preferably in the range of from 60 to 80°.

The invention will now be described with reference to the following examples. It is to be understood that the examples are provided by way of illustration of the invention and that they are in no way limiting to the scope of the invention.

### EXAMPLES

In the examples the geopolymer concrete formulation described in Table 1 were used to prepare various products, which were examined to determine if they would pass the relevant standard requirements.

TABLE 1

| Formulation | | | |
|---|---|---|---|
| As % by mass | | | |
| B-1 | B-3 | B-4 | B-5 |

Fluid components

| | | | | |
|---|---|---|---|---|
| Sodium silicate solution: | 2.85 | 2.81 | 2.66 | 2.54 |
| (44% solids, SiO2/Na2O = 2.0) | | | | |
| Sodium hydroxide solution: | .95 | 0.93 | 0.89 | 0.85 |
| (50% solids) | | | | |
| *Water: | 1.90 | 1.90 | 1.73 | 1.64 |

Binder components

| | | | | |
|---|---|---|---|---|
| Fly ash: | 11.25 | 11.69 | 10.93 | 12.0 |
| Portland cement: | — | 0.28 | — | — |
| Slag: | 1.25 | — | 1.21 | — |

Aggregates

| | | | | |
|---|---|---|---|---|
| Stone (Dry mass): | 49.4 | 54.0 | 2.2 | 52.5 |
| Sand (Dry mass): | 32.4 | 28.4 | 30.4 | 30.5 |

Note:
*Water indicated represents moisture present in the aggregates and water added at the end of the mixing cycle but not any water present in the other fluid components.

To determine the effect of different SiO₂/Na₂O ratios, concrete was prepared using the B-4 formulation shown in Table 1, except that the quantities of sodium silicate to sodium hydroxide were altered to give the ratios shown in Table 2. Although the ratio of fluid components was varied there were no changes to the water or total fluid addition. All other factors including binder and aggregate composition and mixing sequence were kept constant. The effect of these changes to the SiO₂/ Na₂O ratio on Vebe time is shown in Table 2

TABLE 2

| | | | | |
|---|---|---|---|---|
| SiO₂/Na₂O ratio | 1.06 | 1.10 | 0.80 | 0.61 |
| Vebe time (seconds) | | | | |
| Minutes from start of mixing | | | | |
| 15 | 25 | 30 | 30 | 90 |
| 30 | 30 | 40 | 48 | |
| 45 | 35 | 55 | 120 | |
| 60 | 40 | 65 | | |

To make pipes and poles using the methods previously described it is particularly preferred to use concrete that has Vebe times in the range:

15 to 40 seconds (preferably 15 to 35 seconds) at 15 minutes.

15 to 50 seconds (preferably 15 to 50 seconds) at 30 minutes.

15 to 60 seconds at 45 minutes.

Concrete which is outside this range is either too stiff to compact or after compaction it will slump away from the mold. Based on these findings the mix with a SiO₂/Na₂O ratio of 1.06 was chosen for use in the trials to determine the effect of mixing sequence.

The effect of mixing sequence and in particular the effect of adding water at the start of the mixing process was determined from the results shown in Table 3. These trials used the B-4 formulation with variation to the mixing sequence as indicated. In all of the trials, 90 seconds of mixing was allowed for each component and the start of mixing was defined as the time of addition for the first fluid component.

TABLE 3
Mixing Sequence Trials

| Order of addition | | | | |
|---|---|---|---|---|
| Aggregate | 1 | 1 | 1 | 1 |
| Sod. Hydroxide | 2 | 3 | 3 | 4 |
| Binder | 3 | 4 | 4 | 3 |
| Sod. Silicate | 4 | 5 | 2 | 2 |
| Water | 5 | 2 | 5 | 5 |
| SiO₂/Na₂O ratio | 1.06 | 1.06 | 1.06 | 1.06 |
| Vebe time (seconds) | | | | |
| Minutes from start of mixing | | | | |
| 15 | 25 | 70 | 27 | 20 |
| 30 | 30 | 40 | 29 | 20 |
| 45 | 35 | 60 | 40 | 45 |
| 60 | 40 | 60 | 47 | 50 |

The results show that adding water at the start of the mixing cycle, which is equivalent to using aggregates with excessive moisture contents, produces an unacceptable increase in the stiffness of the concrete as indicated by the Vebe times. Other mix sequences can produce concrete of acceptable workability and working time but the most consistent properties are obtained from concrete made with the following mix sequence.
1. Aggregate
2. Sodium Hydroxide solution
3. Binder
4. Sodium Silicate solution
5. Water
   Materials
   For these Examples:

Alkali silicate was in the form of sodium silicate solution containing 44.1% solids, which is made up from 29.4% SiO₂ and 14.7% Na₂O.
Alkali hydroxide was in the form of a sodium hydroxide solution containing 50% solids, which contains 38.75% Na₂O.
The Binder components are chosen from a Class F fly ash, ground granulated blast furnace slag or Portland cement.
The Aggregate components were composed of a 5 mm graded quartz sand and either a 12 mm crushed river gravel or a 14 mm crushed basalt.

Using the above mixing sequence, with aggregates at the prescribed moisture content and chemical components at the optimum ratios, products were made using the existing manufacturing processes. Pipe molds were prepared containing a steel reinforcing cage and the pipes were cast using roller suspension, centrifugal spinning and vertical vibration casting as indicated in the Examples. All Examples used concrete prepared by the following mixing procedure: Stone and sand were intimately mixed with metal hydroxide for approximately 1.5 minute. Binder containing fly ash and any other supplementary materials was added and mixed with the aggregates for 1.5 minutes. Metal silicate was then added and mixed for 1.5 minute and the remaining mixing water added and mixed for 1 minute prior to delivery, by a continuous belt, to the casting equipment. This mixing procedure uses sand in a dry state and stone with a moisture content less than 1.5%. Using the formulations indicated in Table 1 and the above mixing sequence the working time was found to be at least 30 minutes, which was sufficient time to cast the products and when the products were stripped from the mold they were found to have an acceptable finish.

Pipes manufactured by the roller suspension process.

| | Example | | | | |
|---|---|---|---|---|---|
| | 1 | 2 | 3 | 4 | 5 |
| Pipe manufactured | 21/8/03 | 18/9/03 | 3/10/03 | 31/3/04 | 31/3/04 |
| Formulation | B-3 | B-3 | B-3 | B-4 | B-5 |
| Pipe diameter (mm) | 750 | 900 | 1500 | 750 | 750 |
| Pipe Class to AS4058 | 3 | 2 | 2 | 3 | 3 |
| Water absorption (%) | <6.5 | <6.5 | <6.5 | <6.5 | <6.5 |
| Hydrostatic pressure | >90 | >90 | >90 | >90 | >90 |
| (kPa) | | | | | |
| Crack load (kN/m) | >48 | >37 | >54 | >48 | >48 |
| Ultimate load (kN/m) | >72 | >56 | >81 | >72 | >72 |
| Compliance with | Pass | Pass | Pass | Pass | Pass |
| AS4058 | | | | | |

The pipes shown in Examples 1-5 were all 2.4 meters in length.

Pipe manufactured by the centrifugal spinning process

| | Example |
|---|---|
| | 6 |
| Pipe manufactured | 15/10/04 |
| Formulation | B-4 |
| Pipe diameter (mm) | 375 |
| Pipe Class to AS4058 | 2 |
| Water absorption (%) | <6.5 |
| Hydrostatic pressure (kPa) | >90 |
| Crack load (kN/m) | >17 |
| Ultimate load (kN/m) | >26 |
| Compliance with AS4058 | Pass |

The pipe shown in Example 6 was 1.2 meters in length.

Access chamber manufactured by the vertical cast process

| | Example |
|---|---|
| | 7 |
| Manufactured | 6/7/04 |
| Formulation | B-1 |
| Chamber height (mm) | 375 |
| Water absorption (%) | <6.5 |
| Hydrostatic pressure (kPa) | >90 |
| Crack load (kN) | >123 |
| Ultimate load (kN) | >246 |
| Compliance with AS4198 | Pass |

Concrete Mixing Procedure

All concrete was prepared in a rotating pan mixer, which contained counter-rotating mixer blades. Stone and sand were added to the pan and mixed for 1 minute prior to the addition of the next component.

Time of mixing commenced with the addition of the first fluid component and 90 seconds of mixing occurred between the addition of each component.

The Vebe tests were performed at 15 minute intervals starting from the commencement of mixing. All specimens were cast within 15 minutes of mixing and after 60 minutes they were placed in a steam curing chamber at the specified temperature.

1. A method of forming a geopolymer moulded product comprising: forming a geopolymer concrete composition comprising an alkali or alkaline earth metal silicate component, an alkali or alkaline earth metal hydroxide, aggregate and water wherein the water content is insufficient to provide a slumped concrete and the ratio of SiO₂ to M₂O is at least 0.8; and casting the concrete into a mold and subjecting the moulded concrete to consolidation in the mold.

2. A method according to claim 1 wherein a metal M is alkali metal.

3. A method according to claim 1 wherein the ratio of SiO₂ to M₂O is at least 0.9.

4. A method according to claim 1 wherein the ratio of SiO₂ to M₂O is at least 0.95.

5. A method according to claim 1 wherein M₂O is Na₂O and the ratio of SiO₂/Na₂O is in the range of 0.9 to 1.2.

6. A method according to claim 1 wherein at 15 minutes after mixing the concrete has a Vebe time in the range of from 15 to 40 seconds.

7. A method according to claim 6 wherein at 30 minutes the concrete has a Vebe time in the range of 15 to 50 seconds and at 45 minutes the concrete has a Vebe time of from 15 to 60 seconds.

8. A method according to claim 1 used in the molding of concrete products.

9. A method according to claim 1 used in the formation of moulded pipe by methods selected from the group consisting of centrifugal processes, roller suspension process and vertical casting processes.

10. A method according to claim 1 wherein the aluminosilicate material is selected from the group consisting of fly ash, ground blast furnace slag, metakaolin, silica fume, synthetic aluminosilicate, scoria and pumice.

11. A method according to claim 1 wherein at least 70% by weight of the aluminosilicate binder component is fly ash.

12. A method according to claim 1 wherein the aluminosilicate component further comprises an aluminosilicate selected from the group consisting of ground granulated blast furnace slag and Portland cement.

13. A method according to claim 1 wherein the aluminosilicate component comprises at least 70% by weight of fly ash, blast furnace slag in an amount of up to 30% by weight and wherein the composition further comprises ordinary Portland cement in an amount of up to 8% by weight of the total weight of the aluminosilicate binder component.

14. A method according to claim 1 comprising the following components by weight of the total weight of dry components as follows:
40 to 60% course aggregate;
20 to 45% sand;
10 to 20% fly ash;
0.5 to 2% sodium silicate; and
0.2 to 0.6% sodium hydroxide.

15. A method according to claim 1 wherein from half to two thirds of the total water content of the concrete having a water content insufficient to provide a slumped concrete is added to the composition following mixing of the metal hydroxide component and at least part of the aggregate and optionally other components.

16. A method according to claim 1 wherein forming the geopolymer concrete includes the steps of forming a mixture of at least part of the aggregate component with the metal hydroxide and combining the mixture of metal hydroxide and at least part of the aggregate with a binder comprising aluminosilicate material and an activator comprising metal silicate.

17. A method of preparing a geopolymer concrete according to claim 16 wherein at least 50% of the total aggregate component is present in the mixture with the aggregate and metal hydroxide.

18. A method of preparing a geopolymer concrete according to claim 16 wherein the aggregate mixed with the metal hydroxide has a water content of less than 0.8 of the total mass of components.

19. A method of preparing a geopolymer concrete according to claim 16 wherein the geopolymer concrete composition is cast into a mold and compacted into the mold.

20. A method according to claim 16 wherein the concrete composition is cast into a pipe mold by a process selected from the group consisting of centrifugal pipe process, roller suspension process and vertical casting process.

21. A method according to claim 16 wherein the concrete is cast into a pipe mold by a process selected from centrifugal process and roller suspension process.

22. A method according to claim 16 wherein the geopolymer concrete is a no slump concrete.

23. A method according to claim 16 wherein the ratio of sand to stone in the composition is in the range of from 1:1.5 to 1:2.

24. A method according to claim 16 wherein water is present in the mixture of at least part of the aggregate component and metal hydroxide and further water is added with the remaining components and wherein the ratio of water present in the mixture of at least part of the aggregate component and metal hydroxide to the water added with the remaining components is in the range of from 1:2 to 1:3.

25. A concrete pipe product formed by the method according to claim 16.

26. A method according to claim 16 wherein the product is formed by compaction casting of the geopolymer concrete in a pipe mold.

27. A method according to claim 16 wherein the geopolymer concrete is compacted within the pipe mold by a process selected from the group consisting of the centrifugal process and the roller suspension process.
